(19) United States
(12) Patent Application Publication
(10) Pub. No.: US 2010/0097778 A1
(43) Pub. Date: Apr. 22, 2010

(54) Emergency light station with mechanically activated radio frequency signaling

(76) Inventors: William R. Palmer, Rescue, CA (US); Stephen L. Palmer, Cameron Park, CA (US); Joseph Cosimo Longo, Feeding Hills, MA (US); Eric James Domingos, Holyoke, MA (US)

Correspondence Address: MCHALE & SLAVIN, P.A., 2855 PGA BLVD, PALM BEACH GARDENS, FL, 33410, US

(21) Appl. No.: 12/255,464

(22) Filed: Oct. 21, 2008

(51) Int. Cl. F21K 2/06; F21V 15/01

(52) U.S. Cl. 362/34; 362/362

(57) ABSTRACT

A signaling system for an emergency light station containing chemiluminescent light sticks. The light station includes a cover that generates mechanical energy upon opening that is then transformed into electrical power. The electrical power is then utilized to transmit a radio frequency signal to a remote location is alert an observer to the fact that the light station has been opened. The alert provides an immediate indication that an emergency is in progress or that the safety emergency light station is being vandalized.

### RELATED APPLICATIONS

This application is related to patent application Ser. No. 11/875,371 filed Oct. 19, 2007 and Ser. No. 12/017,577 filed Jan. 22, 2008.

### BACKGROUND OF THE INVENTION

The ability to evacuate an area during an emergency is often hampered by the loss of ambient lighting as well as artificial light. For instance, evacuation from a train or airplane wreck will undoubtedly be made more difficult if no light is available. In fact, the loss of lighting will typically cause a panic situation whether the emergency is a wreck, weather related, an earthquake, or simply a power grid failure. When the evacuation includes numerous people, it is a necessity to stop panic and evacuate in an orderly manner for the safety of all involved. For these reasons, the need for emergency lighting is mandatory under most building codes.

Emergency lighting typically takes the form of fixed lighting powered by an AC source with a DC back-up battery. The reliability of a fixed system is dependant upon the maintenance of the back-up battery but in any event remains a fixed system. Evacuation procedures require the individuals to leave an area, thus the fixed lighting system becomes ineffective. Panic stricken individuals may refuse to leave a lighted area. For instance, the evacuation during an earthquake may require individuals to leave a lighted area; the lack of lighting in the exit way may prevent an orderly and safe evacuation. The survivors of a train or plane crash require the individuals to leave the area wherein a fixed light does not provide any mobile coverage. Public transportation vehicles are especially at risk for inadequate lighting in an emergency situation because the power source is typically provided a battery which is continuously charged by the main power source of the vehicle. In use, battery powered lights are obviously only as good as the battery. If the battery has not been properly maintained or replaced, or becomes damaged during an accident, the battery powered light will fail. Due to the limitations of fixed lighting and battery powered systems, a well accepted alternative lighting system is the use of chemiluminescent lightsticks. Chemiluminescent lightsticks provide a reliable portable light source that is produced by a chemical reaction and is not dependent upon any fixed electrical power source or batteries.

The long storage life and the excellent quality of light produced from current chemiluminescent lightsticks have made the product a mainstay in the industry for emergency lighting devices. A “chemiluminescent composition” is intended to mean a mixture or component thereof which will result in chemiluminescent light production when reacted with other necessary reactants in the processes as disclosed herein.

Chemiluminescent lighting devices are commonly used as a supplement and/or replacement for conventional illumination devices such as flashlights and flares. Chemiluminescent devices are non-incandescent products and are most valuable for emergency lighting applications such as when normal electrical power service is interrupted. Additionally, because chemiluminescent devices do not rely on electricity for operation, they are readily and reliably used in wet environments, even under water, where other powered devices could short out and fail. Further, since chemiluminescent light production does not produce significant heat, these devices are not a source of ignition. In a vehicle accident such as a train or airplane crash where spilled fuel or other combustible materials may be present this is of particular importance.

Chemiluminescent light production generally utilizes a two-component system to chemically generate light. Chemiluminescent light is produced by combining the two components, which are usually in the form of chemical solutions referred to as the “oxalate” component and the “activator” component. The two components are kept physically separate by a sealed, frangible, glass vial containing one component which is housed within an outer flexible container containing the other component. Typically, this outer container is sealed to contain both the second component and the filled, frangible vial. Forces created by intimate contact with the internal vial, e.g. by flexing, cause the vial to rupture, thereby releasing the first component, allowing the first and second components to mix and produce light. Since the objective of this type of device is to produce usable light output, the outer vessel is usually composed of a clear or translucent material, such as polyethylene or polypropylene, which permits the light produced by the chemiluminescent system to be transmitted through the vessel walls.

These devices may be designed so as to transmit a variety of colors by either the addition of a dye or fluorescent compound to one or both of the chemiluminescent reactant compositions or to the vessel. Furthermore, the device may be modified so as to only transmit light from particularly chosen portions thereof. Examples of such a chemiluminescent system include: U.S. Pat. No. 5,043,851 issued to Kaplan. Kaplan discloses a polygonal, chemiluminescent lighting device which concentrates light in the corners of the device, thus enhancing visibility of light emanating from the light stick portion of the device and optimizing the amount and distribution of light radiated.

U.S. Pat. No. 4,626,383 to Richter et al. discloses chemiluminescent catalysts in a method for producing light of short duration, high intensity systems, and low temperature systems. This invention relates to catalysts for two component chemiluminescent systems wherein one component is a hydrogen peroxide component and the other component is an oxalate ester-fluorescer component.

U.S. Pat. No. 4,186,426 discloses a chemiluminescent lightstick with an attached actuating device stored inside a container having a hinged lid which opens for access to and for display of the lightstick. The container includes a clamping means by which the lightstick is held at a display position holding the lid of the container open. In this mode, the lightstick and container make a convenient lantern.

U.S. Pat. No. 6,336,729 discloses a lighting system including a chemiluminescent stick supported within a holder. A break bar pivotally connected to the cover is initially in a vertical orientation, and temporarily retained by a latch to allow insertion of the lightstick in the holder and closure of the cover. When the cover is closed, the latch is released, which allows the break bar to move behind the lightstick, in a horizontal orientation. When the cover is then opened, the break bar engages the lightstick, and bends the lightstick forward around an edge to illuminate the lightstick.

U.S. Pat. No. 6,033,080 discloses an emergency light device including a chemiluminescent lightstick which can be easily removed. When an operating lever is pushed, an engaging portion of a pivoting member pushes the bottom portion of the chemiluminescent lightstick toward a wall surface. The chemiluminescent lightstick has on the top end thereof a head secured to a hook of a holding member. The chemiluminescent light stick can be easily bent to illuminate by the lever principle with the protuberance of a case body serving as a fulcrum and the engaging portion serving as the point of action. When the operating lever is further pushed, the top end of the pivoting member protrudes frontward to open a top cover and the holding member which has been restricted by the pivoting member is released and it moves upward by the urging force of a flat spring and the pressing force applied by the head of the chemiluminescent lightstick, thus enabling the chemiluminescent lightstick to be removed.

U.S. Pat. No. 5,446,629 discloses a mounted emergency light fixture. The light fixture has a mount assembly and a front cover with a break plate which bends a lightstick inserted into the fixture when the cover is pivoted from a closed to an open position. The mount assembly has a restraining plate and a back side which maintain the lightstick within the mount when the cover is pivoted to the open position. Hence, after the cover is opened the lightsticks are illuminated and are held in the mount or may be removed to provide emergency lighting.

U.S. Pat. No. 6,065,847 discloses a chemiluminescent lighting device that may include a holder. The holder permits the user to activate the lightstick upon removal from the holder.

U.S. Pat. No. 5,446,629 discloses a mounted emergency light fixture. The light fixture has a mount assembly and a front cover with a break plate which bends a light stick inserted into the fixture when the cover is pivoted from a closed position to an open position. The mount assembly has a restraining plate and a back side which maintain the light stick within the mount when the cover is pivoted to the open position. Hence, after the cover is opened the light sticks are illuminated and are held in the mount or may be removed to provide emergency lighting.

U.S. Pat. No. 7,081,815 discloses a system for remotely monitoring the status of one or more fire extinguishers includes means for sensing at least one parameter of each of the fire extinguishers; means for selectively transmitting the sensed parameters along with information identifying the fire extinguishers from which the parameters were sensed; and means for receiving the sensed parameters and identifying information for the fire extinguisher or extinguishers at a common location. Other systems and methods for remotely monitoring the status of multiple fire extinguishers are also provided.

U.S. Pat. No. 5,572,190 discloses a batteryless sensor includes either a micro miniature generator/gear train or a piezoelectric crystal to convert a movement of a door or window to an ersatz V.sub.cc transient power supply to radiate a coded RF signal to a receiver, a distance away. The receiver may monitor a multiplicity of sensors to identify a source of an intrusion.

U.S. Pat. No. 5,499,013 discloses a mechanical to electrical pulse power generator. Powerful rare-earth magnets (e.g., Neodymium-Iron-Boron, or Samarium-Cobalt) create strong flux fields. These flux fields are used to produce large percent change in flux through a coil of wire upon the triggering of triggering mechanisms which causes a snap action to assure creation of an electrical pulse sufficient to activate an alarm. A mechanical force in a first direction will cause a jerk action which will produce a pulse shape identifiable to the first direction force and a mechanical force in a second direction will produce a different jerk action which will produce a pulse shape identifiable to the second direction force. Low power electronics use the energy in these pulses to activate a radio frequency transmitter to transmit a signal revealing the direction of the mechanical force. A preferred embodiment codes the transmitter signal to indicate the source of the signal.

U.S. Pat. No. 5,317,303 discloses a batteryless sensor that includes a small and concealed permanent magnet motor which operates as a generator to convert rotational or translational energy to an ersatz Vcc transient power supply via a mechanical arrangement to radiate a coded VHF oscillator signal to a repeater or central processing unit located as far as one mile from the sensor. The receiver is able to monitor a multiplicity of sensor units over a given time period.

U.S. Pat. No. 4,853,580 discloses a piezoelectric pulse generator in which a piezoelectric element is acted upon by a rotatable toothed wheel to generate electrical pulses. These pulses may be used to interpret the velocity and rotational direction of the wheel.

U.S. Pat. No. 4,538,139 discloses a signaling apparatus in which a sensed change in condition, e.g. a window opened by an intruder or a valuable art object moved, causes the free end of a cantilevered spring to be snapped or twanged. A piezoelectric film bonded to the spring generates a pulsating voltage which energizes a transmitter, independently of any external power source. Remotely, a receiver which is selectively responsive to the transmitted pulsating signal generates an output signal indicating the change in condition, e.g. for initiating an alarm.

U.S. Pat. No. 3,970,939 discloses a self-contained alarm signal apparatus which includes an electrical signal generator, and encoder connected to receive the output of the generator and to encode a message to be delivered to a transmitter, a source of stored mechanical energy, and connector means for intermittently applying energy from the energy source to the generator for production of an electrical signal. Also provided are first and second input devices for delivering mechanical inputs to the connector means, each of the mechanical inputs operative to cause the connector means to apply energy to the generator. The first input device comprises manually actuable means and the second input device is automatically operable and comprises a timer and means to deliver a mechanical input to the connector means at predetermined time intervals.

U.S. Pat. No. 3,781,836 discloses an alarm system including a magnetic pulse generator for producing an output pulse in response to a change in magnetic flux in response to an intrusion of a designated area, a radio transmitter circuit responding to the pulse from the magnetic pulse generator by transmitting a signal to a remote receiver circuit which in turn generates a pulse for actuating an intrusion alarm circuit.

U.S. Pat. No. 3,614,760 discloses a signaling system that employs a transmitter energized by a momentary power generator which responds to a brief mechanical input. The input may be due to intentional signaling activity, unintentional triggering of a burglar detection device, or it may be in response to an ambient condition such as elevated temperatures indicating a fire is in progress. The mechanical event vibrates a spring-mass pendulum. The vibrating mass traverses an air gap in a magnetic circuit to induce an alternating potential in a signal output coil. The output of this generator is rectified to provide power for one or more radio frequency transmitters, and in addition may be used as the modulating signal impressed upon the radio frequency carrier. Two radio frequency transmitters operating at different carrier frequencies may be modulated by different phase components of the generator frequency. Alternatively, the modulation may be supplied by one or more subcarrier generators energized by the mechanical power generator. For greater noise immunity, a variation of this system may employ coded combinations of subcarrier frequencies.

U.S. Publication No. 2007/0194916 discloses a container that includes an enclosure portion, a door moveable from a closed position to an open position relative to the enclosure portion, and a sensing apparatus. The sensing apparatus includes a signal-emitting device providing a first wireless signal and having a first mounting structure non-invasively mounted to one of the enclosure portion and door. The sensing apparatus further includes a wireless sensing device including a sensing element configured to sense the first signal and a second mounting structure non-invasively mounted to the other of the enclosure portion and door. The sensing element is able to sense the first wireless signal when the door is in the closed position, and thus determine when the door is opened and closed. The signal emitting device and sensing device may each be releasably secured via adhesives so they can be used with different containers.

U.S. Publication No. 2007/0096918 discloses an indicating device configured to indicate that a package has been opened includes a voltage generator configured to convert a mechanical stress caused by opening of the package into a voltage and a circuit configured to employ the voltage to create a package opened indicator. The device also includes a data storage device configured to store the package opened indicator as electronic data.

U.S. Publication No. 2007/0182535 discloses a self-powered sensor that detects or measures an event by converting one form of energy into another form. The converted energy may be conditioned and regulated to drive a wireless transmitter and encoder. A receiver may detect and validate a received message. If validated, the message may be processed or decrypted and processed to determine what has been identified or requested.

The above mentioned prior art all recognize the need for quick access to a lightstick to address emergency situations and the need to have the lightstick readily available. Co-pending applications Ser. No. 11/875,371 filed Oct. 19, 2007 and filed Jan. 22, 2008 provide for storage containers for chemiluminescent lightsticks, the storage containers including a means for automatically latching the storage device and activating at least one lightstick producing light for illumination of the container and any remaining lightsticks.

While placement of such systems in subway tunnels and on trains and in similar locations will greatly enhance the safety of these environments, should an emergency occur, two problems remain. First, safety appliances which are located in public areas are sometimes subject to vandalism or deliberate misuse. For example, persons may steal fire extinguishers so that they can be used for pranks or to promote additional vandalism. Likewise a lightstick container may be opened so that the lightsticks can be stolen from the container. Since lightsticks are relatively small they can easily be concealed and are readily carried away. Some form of audible alarm or visible signaling means to indicate that the container had been opened could be used for this purpose, however, absent an observer; this would be of little use. The better solution would include a system that alerts a remote system or operator that the container has been opened. With such a system, potential vandals could be made aware that their action will signal a swift response. Threat of this response would serve as a deterrent to vandalism. The second problem is that valuable time can be lost in a real emergency between the time that an individual container is opened, thereby possible signaling an emergency event, and the time that the emergency event is reported to those who must respond such as fire or police. A remote signaling system which immediately alerts the proper authorities when a container was opened would be significantly reduce the reaction time for first responders. A system which did not require that signal wires be used to convey the “container opened” signal to a monitoring station would be preferred. A wireless system would be less expensive to install, easier to maintain and less vulnerable to physical damage. What is lacking in the art then is a storage container for chemiluminescent lightsticks, which is self-powered and provides a wireless signal to a receiving station indicating that the container has been utilized and that an emergency situation may exist near the location of the container.

Efficient design and use of modern materials permit even meager mechanical actions to be converted to useful electrical energy. While this energy may be limited when compared to that produced by conventional chemical batteries such as alkaline or lithium cells, nevertheless this energy is sufficient to perform useful tasks. Additionally, recent developments in energy harvesting technologies, which allow small quanta of electrical energy to be efficiently collected and stored, can be employed to further enhance the production of useful electrical energy from relatively meager mechanical actions.

While traditional electrochemical cells, commonly referred to as batteries, are frequently employed to power a variety of electrically operated devices, there are situations in which the use of such energy sources is prohibited or otherwise undesirable. For example, environments such as mines and hospital operating rooms may contain explosive gasses or vapors which contraindicate the use of certain stored energy devices such as electrochemical batteries. Similarly, fuel and/or cargo spills at accident sites may prevent the safe use of conventional energy supplies. Additionally, use of traditional electrical energy sources in such atmospheres may require the use of explosion-proof fixtures and/or intrinsically safe wiring, both of which are costly to install. Further, traditional batteries are always “on”, that is, they have an open circuit voltage which can be capable of creating sparks and heat if a conductive object should come in contact with the battery terminals or other energized circuit elements. Such sparks and heat could cause a fire or explosion in the presence of flammable gasses or vapors such as may be found in a train or plane crash. Still further, these batteries must be monitored and periodically replaced as they become worn out due to age.

It is therefore an object of this invention to provide an emergency light station with a self-powered alarm signal.

A further object of this invention is to provide an emergency light station from which lightsticks can be removed for portable use.

It is yet another object of this invention to provide an emergency light station which is capable of transmitting a signal essentially simultaneously with opening of the station.

Still another object of this invention is to provide an emergency light station in which the energy to power an RF transmitter is derived from a meager mechanical action.

Another object of this invention is to provide an emergency light station in which the electrical power source does not degrade as is the case with chemical batteries. Yet another object of this invention is to provide a means of deterring theft or vandalism of emergency light stations.

Another object of this invention is to provide a means of indication that an emergency event has occurred at a remote site.

Yet another object of this invention is to provide an emergency light station which reports an identification code which signals the receiver as to which device has been activated.

Another object of this invention is to provide an emergency light station which reports an identification code which signals the receiver as to the status of the emergency light station.

Still another object of this invention is to provide an emergency light station which is capable of operating with other devices as part of a network.

Yet another object of this invention is to provide an emergency light station with remote signaling that does not generate an electrical potential until activated.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objectives and features thereof.

### BRIEF DESCRIPTION OF THE DRAWINGS

FIG. 1 illustrates an emergency light station prior to operation; and

FIG. 2 illustrate an emergency light station with the cover open.

### DETAILED DESCRIPTION OF THE INVENTION

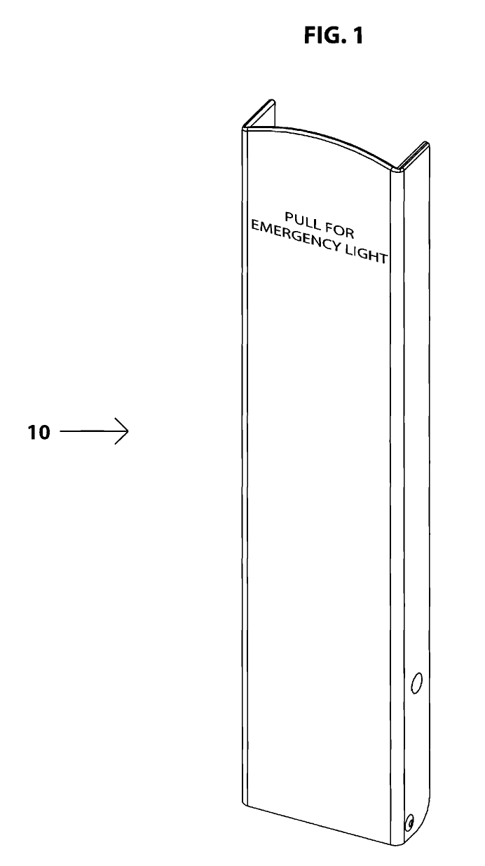

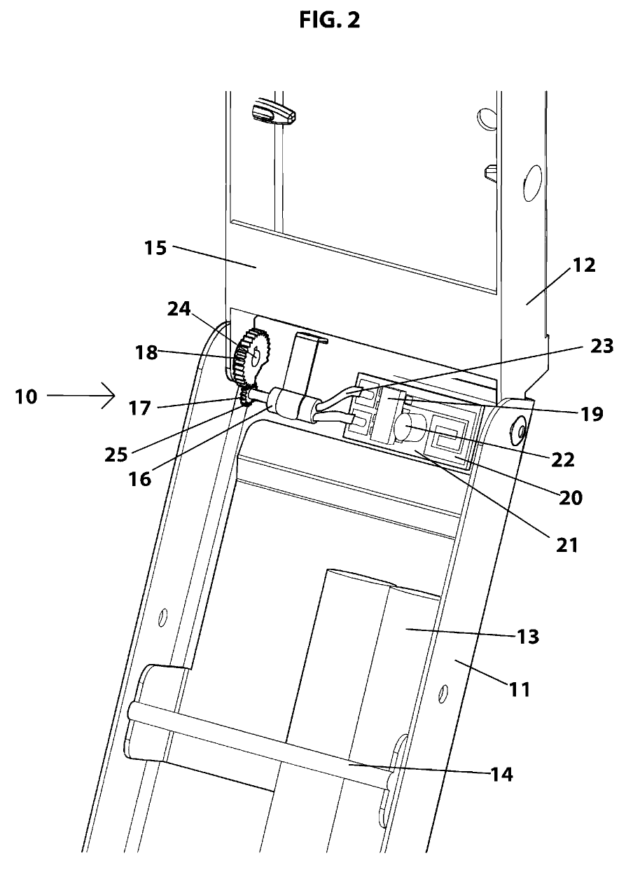

Referring to FIG. 1, an emergency light station (10) with radio frequency signaling is provided. As previously described the light station contains a plurality of lightsticks. When the container cover is opened, a portion of these lightsticks are automatically activated and made available to the user. Before opening, the light sticks are protected by the container from light exposure, accidental activation and theft. Now, referring to FIG. 2, Front cover (11) is hinged with respect to mounting base (12). Upon opening, chemiluminescent lightstick(s) (13) which are disposed in the container are submitted to a bending force created by interaction of breaker bar (14) and retainer plate (15). At some point, the force on chemiluminescent lightstick (13) is sufficient to cause it to be activated. Gear (18), is non-rotatably attached to mounting base hinge pin (24), said pin being non-rotatably attached to mounting base (12).

Gear (18) meshes with drive gear (17) and causes drive gear (17) to rotate relative to generator (16) as front cover (11) is opened relative to mounting base (12). Drive gear (17) is coupled to generator (16) by a one-way ratchet/spring assembly (25) commonly referred to as a “Bendix drive”. The ratchet/spring assembly permits energy to be stored in the spring while front cover (11) is being opened.

Generator (16) is of a one-way design such that rotation is permitted in only one direction. While front cover (11) is being opened, energy is stored in the spring but because of its one-way design, generator (16) does not rotate. When front cover (11) has opened to a degree that gear (18) is no longer engaged with drive gear (17), the spring causes drive gear (17) to spin in the opposite direction of the aforementioned rotation of drive gear (17) which occurs during opening of front cover (11) relative to mounting base (12). Because of the one-way ratchet in ratchet/spring assembly (25), the rotation of drive gear (17) is now transmitted to generator (16) whereupon electrical power is generated.

The mass of drive gear (17) and ratchet/spring assembly (25) serve as a flywheel so that generator (16) may spin for a considerable time. During this time, electrical energy produced by the generator (16) is transmitted by an electrical connector (23) to circuit board (21) which comprises an energy storage device (22) such as a capacitor or a rechargeable battery or an energy harvesting circuit.

Electrical energy from energy storage device (22) is provided to controller/transmitter (19) which consists of an RF transmitter and optionally, some form of control circuit. The control circuit providing control of electrical energy, transmitter modulation and so forth as may be desired. The transmitter is capable of sending a signal with a particular identifier code such that the location can be identified from a remote location.

Any form of radio frequency modulation or no modulation may be employed as may be desired. An antenna (20) is employed to cause the RF signal to be propagated in free space. Since the electromechanical generator, energy storage device and the controller/transmitter can function instantly and essentially simultaneously with lightstick station operation, RF signal transmission is virtually guaranteed prior to the user removing the lightstick(s) from the light station, thereby providing the earliest possible indication that an emergency event may have taken place. Generator (16) may of course be an electromagnetic generator, as are well known. Generator (16) may also be a Piezo-electric generator.

In the most basic form, the invention is a signaling system having a housing for storage of lighting products such as light sticks, flashlights, or other emergency lighting devices. The housing has a base and cover, said cover moveable between an open position and a closed position with respect to the base. A mechanical linkage is positioned between the cover and the base, the mechanical linkage is configured to transform the relative movement of the cover with respect to the base into mechanical energy. An electrical generator is coupled to the mechanical linkage whereby rotation or a lifting of the cover causes operation of the electrical generator to produce electrical energy. A wireless signal transmitter is powered by the electrical energy to signal that the housing has been opened.

While it is contemplated that this system will find application in transportation vessels, factories, schools, hotels and public venues in general, it is also recognized that it may be employed in lifeboats to signal orbiting satellites that an emergency event has taken place, or as man-portable devices which may be carried by individuals.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and drawings/figures.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A signaling system comprising:
a housing for storage of lighting products, said housing having a base and cover, said cover moveable between an open position and a closed position with respect to said base;
a mechanical linkage between said cover and said base, said mechanical linkage configured to transform the relative movement of said cover with respect to said base into mechanical energy;
an electrical generator coupled to said mechanical linkage whereby rotation of said cover causes operation of said electrical generator to produce electrical energy; and
a wireless signal transmitter powered by said electrical energy.

2. The signaling system of claim 1 wherein said mechanical linkage includes at least two interoperable gears.

3. The signaling system of claim 2, wherein one of said two interoperable gears is fixed against rotation about its axis and the other is freely rotatable about its axis.

4. The signaling system of claim 2, wherein said mechanical linkage includes a one way ratchet spring assembly mechanically connected to one of said two interoperable gears and a mechanical input of said electrical generator.

5. The signaling system of claim 1, wherein said transmitter includes a transmitter control circuit.

6. The signaling system of claim 1, wherein an electrical output of said generator is electrically connected to an energy storage device and said transmitter.

7. The signaling system of claim 1, wherein an output of said transmitter is electrically connected to an antenna.

8. The signaling system of claim 1, wherein the housing includes a retainer plate for storage of chemiluminescent light sticks within said housing.

9. The signaling system of claim 8, wherein said housing includes a breaker bar which engages and activates said chemiluminescent light sticks upon moving said cover to an open position.

10. A signaling system for an emergency chemiluminescent light station comprising:
said emergency chemiluminescent light station including a housing having a base and a cover;
said emergency chemiluminescent light station configured to have chemiluminescent light sticks mounted therein;
said cover moveable between an open position and a closed position with respect to said base;
a mechanical linkage between said cover and said base;
said mechanical linkage configured to transform the relative movement of the cover with respect to the base into mechanical energy;
said emergency light station further including an electrical generator; inputting said mechanical energy into said electrical generator to produce electrical energy;
said emergency light station further including a wireless signal transmitter, wherein said wireless signal transmitter is powered by said electrical energy.

11. The signaling system for an emergency chemiluminescent light station of claim 10, wherein said mechanical linkage includes at least two interoperable gears.

12. The signaling system for an emergency chemiluminescent light station of claim 11, wherein one of said two interoperable gears is fixed against rotation about its axis and the other is freely rotatable about its axis.

13. The signaling system for an emergency chemiluminescent light station of claim 11, wherein said mechanical linkage includes a one way ratchet spring assembly mechanically connected to one of said two interoperable gears and a mechanical input of said electrical generator.

14. The signaling system for an emergency chemiluminescent light station of claim 10, wherein said transmitter includes a transmitter control circuit.

15. The signaling system for an emergency chemiluminescent light station of claim 10, wherein an electrical output of said generator is electrically connected to an energy storage device and said transmitter.

16. The signaling system for an emergency chemiluminescent light station of claim 10, wherein an output of said transmitter is electrically connected to an antenna.

17. The signaling system for an emergency chemiluminescent light station of claim 10, wherein the housing includes a retainer plate for mounting said chemiluminescent light sticks within said housing.

18. The signaling system for an emergency chemiluminescent light station of claim 17, wherein said housing includes a breaker bar which engages and activates said chemiluminescent light sticks upon moving said cover to an open position.
